(19) United States
(12) Patent Application Publication
(10) Pub. No.: US 2023/0018450 A1
(43) Pub. Date: Jan. 19, 2023

(54) POWER STORAGE DEVICE

(71) Applicant: TOYOTA JIDOSHA KABUSHIKI KAISHA, Toyota-shi Aichi-Ken (JP)

(72) Inventor: Shinya Goitsuka, Nisshin-shi Aichi-ken (JP)

(73) Assignee: TOYOTA JIDOSHA KABUSHIKI KAISHA, Toyota-shi Aichi-Ken (JP)

(21) Appl. No.: 17/861,491

(22) Filed: Jul. 11, 2022

(30) Foreign Application Priority Data
Jul. 13, 2021 (JP) 2021-115663

(51) Int. Cl. H01M 10/6556; H01M 10/613; H01M 10/6567

(52) U.S. Cl. CPC H01M 10/6556; H01M 10/613; H01M 10/6567

(57) ABSTRACT

A power storage device includes a plurality of power storage modules, a case, a cooler provided below the case, and a thermally conductive material. The cooler includes a cooling flow path. The power storage module includes an upstream-side stack, a downstream-side stack, and an intermediate plate. The case has a bottom wall having a protrusion protruding toward the intermediate plate. The thermally conductive material includes: an upstream-side thermally conductive portion disposed upstream of the protrusion; and a downstream-side thermally conductive portion disposed downstream of the protrusion. The downstream-side thermally conductive portion is smaller in thickness than the upstream-side thermally conductive portion.

This nonprovisional application is based on Japanese Patent Application No. 2021-115663 filed on Jul. 13, 2021 with the Japan Patent Office, the entire contents of which are hereby incorporated by reference.

### BACKGROUND

### Field

The present disclosure relates to a power storage device.

### Description of the Background Art

For example, Japanese Patent Laying-Open No. 2020-53148 discloses a battery unit including: a battery module including a plurality of battery cells arranged side by side in one direction; a cooler disposed below the battery module; and grease provided between the battery module and the cooler. The cooler includes a coolant flow path through which a coolant (cooling water) flows. The coolant flow path is shaped to extend in the one direction. The coolant flows from one end side to the other end side of the coolant flow path in the one direction.

### SUMMARY

In the battery unit disclosed in Japanese Patent Laying-Open No. 2020-53148, the temperature of the coolant flowing through the coolant flow path rises toward the downstream side of the coolant flow path. Thus, the degree by which the power storage cells are cooled by the coolant decreases on the downstream side of the coolant flow path. This causes a concern about occurrence of variations between the temperature of the power storage cells disposed upstream of the coolant flow path and the temperature of the power storage cells disposed downstream of the coolant flow path.

An object of the present disclosure is to provide a power storage device capable of suppressing variations between the temperature of the power storage cells disposed upstream of a cooling flow path and the temperature of the power storage cells disposed downstream of the cooling flow path.

A power storage device according to an aspect of the present disclosure includes: a power storage module including a plurality of power storage cells arranged side by side in one direction; a case that accommodates the power storage module; a cooler that is provided below the case and cools the power storage module through the case; and a thermally conductive material disposed between a lower surface of the power storage module and the case. The cooler includes a cooling flow path through which a cooling medium flows in the one direction. The power storage module includes: an upstream-side stack disposed upstream in a flow direction of the cooling flow path and including some of the power storage cells; a downstream-side stack disposed downstream of the upstream-side stack in the flow direction and including power storage cells other than power storage cells included in the upstream-side stack among the power storage cells; and an intermediate plate disposed between the upstream-side stack and the downstream-side stack. The case has a bottom wall disposed below the power storage module. The bottom wall has a protrusion protruding toward the intermediate plate. The thermally conductive material includes: an upstream-side thermally conductive portion disposed upstream of the protrusion in the flow direction and between the upstream-side stack and the bottom wall; and a downstream-side thermally conductive portion disposed downstream of the protrusion in the flow direction and between the downstream-side stack and the bottom wall. The downstream-side thermally conductive portion is smaller in thickness than the upstream-side thermally conductive portion.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view schematically showing a configuration of a power storage device according to one embodiment of the present disclosure.

FIG. 2 is an exploded perspective view of the power storage device.

FIG. 3 is a cross-sectional view taken along a line III-III in FIG. 1.

FIG. 4 is a cross-sectional view schematically showing the state before a power storage module is placed on a lower case.

### DESCRIPTION OF THE EMBODIMENTS

Embodiments of the present disclosure will be hereinafter described with reference to the accompanying drawings, in which the same or corresponding members are denoted by the same reference numerals.

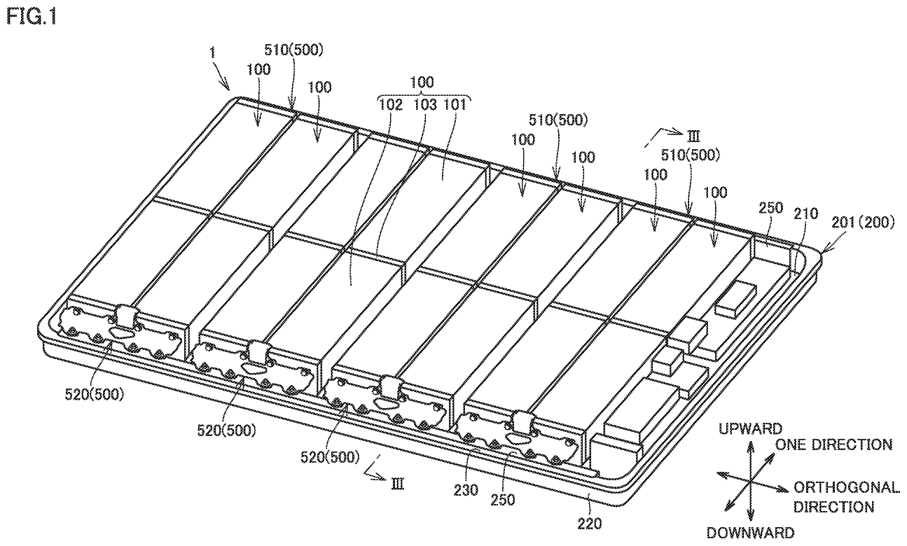

FIG. 1 is a perspective view schematically showing a configuration of a power storage device according to one embodiment of the present disclosure. A power storage device 1 is mounted on a vehicle, for example.

As shown in FIGS. 1 to 3, power storage device 1 includes a plurality of power storage modules 100, a case 200, a cooler 300, a thermally conductive material 400, and a pressing member 500.

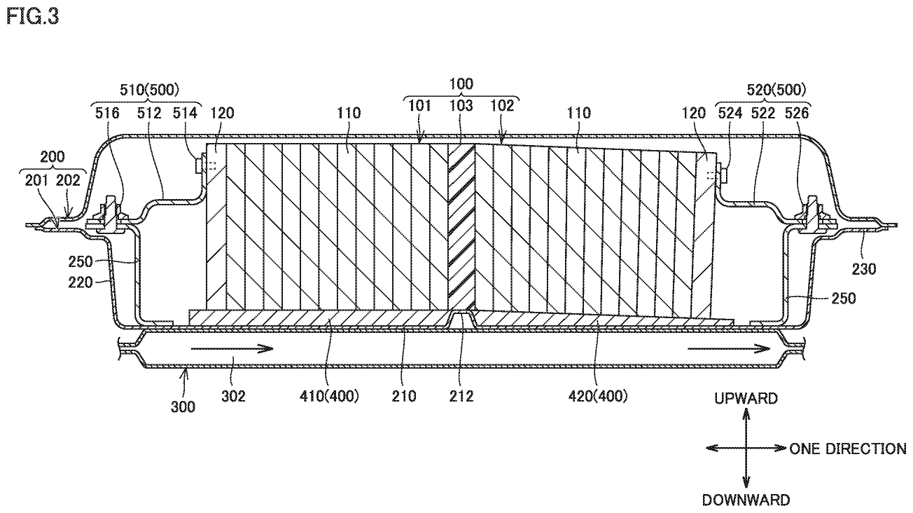

As shown in FIG. 3, each power storage module 100 includes a plurality of power storage cells 110 and a pair of end plates 120.

The plurality of power storage cells 110 are arranged side by side in one direction. Examples of power storage cell 110 include a lithium ion battery. Each power storage cell 110 is formed in a rectangular parallelepiped shape. As shown in FIG. 1, the plurality of power storage modules 100 are arranged side by side in an orthogonal direction orthogonal to both the above-mentioned one direction and an upward/downward direction.

The pair of end plates 120 are disposed on both sides of the plurality of power storage cells 110 in the one direction. Each end plate 120 is made of metal (aluminum or the like).

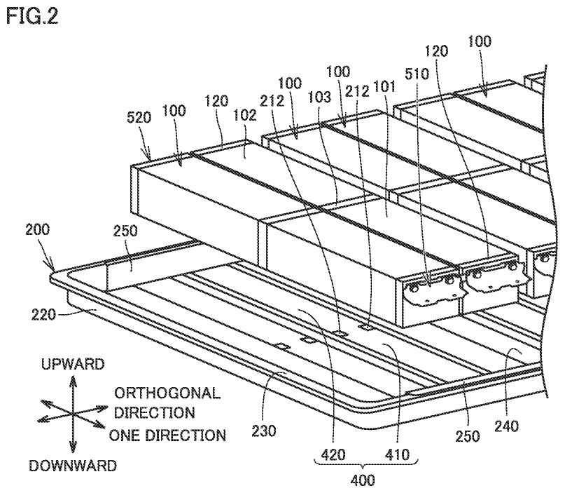

Case 200 accommodates the plurality of power storage modules 100. Case 200 includes a lower case 201 and an upper case 202 (see FIG. 3). FIGS. 1 and 2 each do not show upper case 202.

Lower case 201 is shaped to open upward. Lower case 201 is made of metal. Lower case 201 includes a bottom wall 210, a circumferential wall 220, a flange 230, a partition wall 240 (see FIG. 2), and a reinforcing bracket 250.

Bottom wall 210 is disposed below the plurality of power storage modules 100. As shown in FIGS. 2 and 3, a protrusion 212 that protrudes upward is formed in a central portion of bottom wall 210 in the one direction. The top portion of protrusion 212 is formed to be flat.

Circumferential wall 220 is provided upright from the circumferential edge of bottom wall 210 and surrounds the plurality of power storage modules 100.

Flange 230 is shaped to protrude outward from an upper end portion of circumferential wall 220.

As shown in FIG. 2, partition wall 240 provides a partition between a pair of power storage modules 100 adjacent to each other in the orthogonal direction. Both ends of partition wall 240 in the one direction are connected to circumferential wall 220. In other words, partition wall 240 has a function of reinforcing circumferential wall 220.

Reinforcing bracket 250 is disposed between circumferential wall 220 and power storage module 100 in the one direction. Reinforcing bracket 250 reinforces the attachment of power storage module 100 to bottom wall 210. As shown in FIG. 3, a lower end portion of reinforcing bracket 250 is connected to bottom wall 210 by welding or the like. As shown in FIGS. 1 and 2, an upper end portion of reinforcing bracket 250 is fixed to flange 230 by welding or the like.

As shown in FIG. 3, upper case 202 is shaped to open downward. Together with lower case 201, upper case 202 accommodates the plurality of power storage modules 100. Upper case 202 is made of metal.

As shown in FIG. 3, cooler 300 is provided below case 200 to cool each power storage module 100 through case 200. Cooler 300 is in contact with a lower surface of bottom wall 210. In some embodiments, a thermally conductive material is provided between cooler 300 and bottom wall 210. Cooler 300 includes a cooling flow path 302 through which a cooling medium (water or the like) flows in the one direction.

As shown in FIGS. 2 and 3, each power storage module 100 includes an upstream-side stack 101, a downstream-side stack 102, and an intermediate plate 103.

Upstream-side stack 101 is disposed upstream in the flow direction of cooling flow path 302. Upstream-side stack 101 includes some of the plurality of power storage cells 110 included in power storage module 100.

Downstream-side stack 102 is disposed downstream of upstream-side stack 101 in the flow direction. Downstream-side stack 102 includes power storage cells 110 other than power storage cells 110 included in upstream-side stack 101 among the plurality of power storage cells 110 included in power storage module 100. In the present embodiment, the number of power storage cells 110 included in downstream-side stack 102 is the same as the number of power storage cells 110 included in upstream-side stack 101. As shown in FIG. 3, downstream-side stack 102 is inclined with respect to bottom wall 210 such that downstream-side stack 102 gradually approaches bottom wall 210 toward the downstream side in the flow direction.

Intermediate plate 103 is disposed between upstream-side stack 101 and downstream-side stack 102. In other words, intermediate plate 103 is disposed at the center of power storage module 100 in the one direction, upstream-side stack 101 is disposed upstream of intermediate plate 103 in the flow direction, and downstream-side stack 102 is disposed downstream of intermediate plate 103 in the flow direction. As shown in FIG. 3, intermediate plate 103 is placed on protrusion 212 of bottom wall 210.

Thermally conductive material 400 is disposed between a lower surface of power storage module 100 and case 200. More specifically, thermally conductive material 400 is disposed between a lower surface of each power storage cell 110 and an upper surface of bottom wall 210. Thermally conductive material 400 is made of grease or the like. As shown in FIGS. 2 and 3, thermally conductive material 400 includes an upstream-side thermally conductive portion 410 and a downstream-side thermally conductive portion 420.

Upstream-side thermally conductive portion 410 is disposed upstream of protrusion 212 in the flow direction and between upstream-side stack 101 and bottom wall 210. Upstream-side thermally conductive portion 410 has a substantially uniform thickness in the one direction.

Downstream-side thermally conductive portion 420 is disposed downstream of protrusion 212 in the flow direction and between downstream-side stack 102 and bottom wall 210. Downstream-side thermally conductive portion 420 is smaller in thickness than upstream-side thermally conductive portion 410. As shown in FIG. 3, downstream-side thermally conductive portion 420 is gradually reduced in thickness toward the downstream side in the flow direction. Note that downstream-side thermally conductive portion 420 may have a substantially uniform thickness in the one direction as long as downstream-side thermally conductive portion 420 is smaller in thickness than upstream-side thermally conductive portion 410. Protrusion 212 functions as a reference for each of the thickness of upstream-side thermally conductive portion 410 and the thickness of downstream-side thermally conductive portion 420.

Pressing member 500 serves to press power storage module 100 against bottom wall 210. Pressing member 500 serves to attach power storage module 100 to case 200 in the state in which power storage module 100 is pressed against bottom wall 210 such that thermally conductive material 400 is compressed. Pressing member 500 includes an upstream-side pressing portion 510 and a downstream-side pressing portion 520.

Upstream-side pressing portion 510 presses an upstream-side end portion (end plate 120) of upstream-side stack 101 in the flow direction against bottom wall 210. Upstream-side pressing portion 510 includes an upstream-side bracket 512, a first upstream-side fastening member 514, and a second upstream-side fastening member 516.

Upstream-side bracket 512 serves as a member for attaching upstream-side stack 101 to case 200. Upstream-side bracket 512 is made of metal. An inner end portion of upstream-side bracket 512 in the one direction is fixed to the upstream-side end portion (end plate 120) of upstream-side stack 101 by first upstream-side fastening member 514. An outer end portion of upstream-side bracket 512 in the one direction is fixed to the upper end portion of reinforcing bracket 250 by second upstream-side fastening member 516.

Downstream-side pressing portion 520 presses a downstream-side end portion (end plate 120) of downstream-side stack 102 in the flow direction against bottom wall 210. Downstream-side pressing portion 520 presses the downstream-side end portion of downstream-side stack 102 against bottom wall 210 such that downstream-side thermally conductive portion 420 becomes smaller in thickness than upstream-side thermally conductive portion 410. Downstream-side pressing portion 520 includes a downstream-side bracket 522, a first downstream-side fastening member 524, and a second downstream-side fastening member 526.

Downstream-side bracket 522 serves as a member for attaching downstream-side stack 102 to case 200. Downstream-side bracket 522 is made of metal. An inner end portion of downstream-side bracket 522 in the one direction is fixed to the downstream-side end portion (end plate 120) of downstream-side stack 102 by first downstream-side fastening member 524. An outer end portion of downstream-side bracket 522 in the one direction is fixed to the upper end portion of reinforcing bracket 250 by second downstream-side fastening member 526.

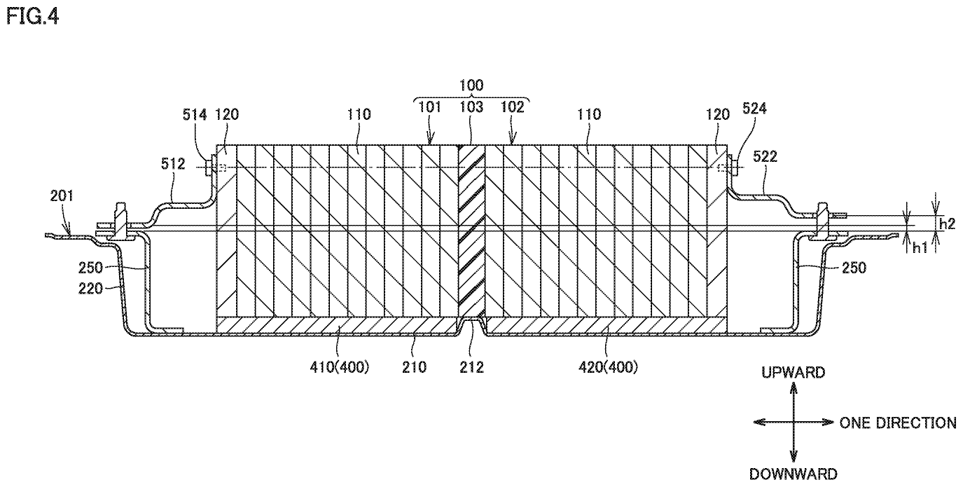

FIG. 4 shows the state before intermediate plate 103 is placed on protrusion 212 and the outer end portions of brackets 512 and 522 are fastened. As shown in FIG. 4, a dimension h2 between the upper end portions of downstream-side bracket 522 and reinforcing bracket 250 is larger than a dimension h1 between the upper end portions of upstream-side bracket 512 and reinforcing bracket 250. In this case, dimension h2 between the upper end portions of downstream-side bracket 522 and reinforcing bracket 250 is a dimension in the state before intermediate plate 103 is placed on protrusion 212, the inner end portion of downstream-side bracket 522 is fixed to end plate 120 by first downstream-side fastening member 524, and the outer end portion of downstream-side bracket 522 is fixed to the upper end portion of reinforcing bracket 250. Dimension h1 between the upper end portions of upstream-side bracket 512 and reinforcing bracket 250 is a dimension in the state before intermediate plate 103 is placed on protrusion 212, the inner end portion of upstream-side bracket 512 is fixed to end plate 120 by first upstream-side fastening member 514, and the outer end portion of upstream-side bracket 512 is fixed to the upper end portion of reinforcing bracket 250. Further, the height from bottom wall 210 to the point at which first upstream-side fastening member 514 is fastened to end plate 120 is the same as the height from bottom wall 210 to the point at which first downstream-side fastening member 524 is fastened to end plate 120. In other words, the dimension of downstream-side bracket 522 in the upward/downward direction is smaller than the dimension of upstream-side bracket 512 in the upward/downward direction. Thus, when second upstream-side fastening member 516 and second downstream-side fastening member 526 are fastened, downstream-side thermally conductive portion 420 becomes smaller in thickness than upstream-side thermally conductive portion 410, as shown in FIG. 3.

As described above, in power storage device 1 of the present embodiment, downstream-side thermally conductive portion 420 is smaller in thickness than upstream-side thermally conductive portion 410, and therefore, the degree by which downstream-side stack 102 is cooled by the cooling medium increases. This suppresses variations between the temperature of power storage cells 110 included in upstream-side stack 101 and the temperature of power storage cells 110 included in downstream-side stack 102.

In the above-described embodiment, reinforcing bracket 250 may not be provided, and the outer end portions of brackets 512 and 522 in the one direction may be fixed, for example, to flange 230 of case 200.

Further, upstream-side bracket 512 and downstream-side bracket 522 may have the same shape, and the height from bottom wall 210 to the point at which first downstream-side fastening member 524 is fastened to end plate 120 may be greater than the height from bottom wall 210 to the point at which first upstream-side fastening member 514 is fastened to end plate 120.

It will be appreciated by those skilled in the art that the above-described illustrative embodiments are specific examples of the following aspects.

A power storage device according to the above-described embodiment includes: a power storage module including a plurality of power storage cells arranged side by side in one direction; a case that accommodates the power storage module; a cooler that is provided below the case and cools the power storage module through the case; and a thermally conductive material disposed between a lower surface of the power storage module and the case. The cooler includes a cooling flow path through which a cooling medium flows in the one direction. The power storage module includes: an upstream-side stack disposed upstream in a flow direction of the cooling flow path and including some of the power storage cells; a downstream-side stack disposed downstream of the upstream-side stack in the flow direction and including power storage cells other than power storage cells included in the upstream-side stack among the power storage cells; and an intermediate plate disposed between the upstream-side stack and the downstream-side stack. The case has a bottom wall disposed below the power storage module. The bottom wall has a protrusion protruding toward the intermediate plate. The thermally conductive material includes: an upstream-side thermally conductive portion disposed upstream of the protrusion in the flow direction and between the upstream-side stack and the bottom wall, and a downstream-side thermally conductive portion disposed downstream of the protrusion in the flow direction and between the downstream-side stack and the bottom wall. The downstream-side thermally conductive portion is smaller in thickness than the upstream-side thermally conductive portion.

In the present power storage device, the downstream-side thermally conductive portion is smaller in thickness than the upstream-side thermally conductive portion, and therefore, the degree by which the downstream-side stack is cooled by the cooling medium increases. This suppresses variations between the temperature of the power storage cells included in the upstream-side stack and the temperature of the power storage cells included in the downstream-side stack.

In some embodiments, the downstream-side thermally conductive portion is gradually reduced in thickness toward a downstream side in the flow direction.

This makes it possible to more reliably suppress variations between the temperature of the power storage cells included in the upstream-side stack and the temperature of the power storage cells included in the downstream-side stack.

In some embodiments, the power storage device further includes a pressing member that presses the power storage module against the bottom wall, the pressing member includes: an upstream-side pressing portion that presses an upstream-side end portion of the upstream-side stack in the flow direction against the bottom wall; and a downstream-side pressing portion that presses a downstream-side end portion of the downstream-side stack in the flow direction against the bottom wall, and the downstream-side pressing portion presses the downstream-side end portion of the downstream-side stack against the bottom wall such that the downstream-side thermally conductive portion becomes smaller in thickness than the upstream-side thermally conductive portion.

Further, the upstream-side pressing portion may include: an upstream-side bracket that serves to attach the upstream-side stack to the case; a first upstream-side fastening member that fastens the upstream-side bracket to the upstream-side stack; and a second upstream-side fastening member that fastens the upstream-side bracket to the case, and the downstream-side pressing portion may include: a downstream-side bracket that serves to attach the downstream-side stack to the case; a first downstream-side fastening member that fastens the downstream-side bracket to the downstream-side stack; and a second downstream-side fastening member that fastens the downstream-side bracket to the case. In some embodiments, a dimension between the downstream-side bracket and the case is larger than a dimension between the upstream-side bracket and the case, the dimension between the downstream-side bracket and the case is a dimension in a state before the intermediate plate is placed on the protrusion, the downstream-side bracket is fixed to the downstream-side stack by the first downstream-side fastening member, and the downstream-side bracket is fixed to the case by the second downstream-side fastening member, and the dimension between the upstream-side bracket and the case is a dimension in a state before the intermediate plate is placed on the protrusion, the upstream-side bracket is fixed to the upstream-side stack by the first upstream-side fastening member, and the upstream-side bracket is fixed to the case by the second upstream-side fastening member.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage device comprising:
a power storage module including a plurality of power storage cells arranged side by side in one direction;
a case that accommodates the power storage module;
a cooler that is provided below the case and cools the power storage module through the case; and
a thermally conductive material disposed between a lower surface of the power storage module and the case, wherein
the cooler includes a cooling flow path through which a cooling medium flows in the one direction,
the power storage module includes
an upstream-side stack disposed upstream in a flow direction of the cooling flow path and including some of the power storage cells,
a downstream-side stack disposed downstream of the upstream-side stack in the flow direction and including power storage cells other than power storage cells included in the upstream-side stack among the power storage cells, and
an intermediate plate disposed between the upstream-side stack and the downstream-side stack,
the case has a bottom wall disposed below the power storage module,
the bottom wall has a protrusion protruding toward the intermediate plate,
the thermally conductive material includes
an upstream-side thermally conductive portion disposed upstream of the protrusion in the flow direction and between the upstream-side stack and the bottom wall, and
a downstream-side thermally conductive portion disposed downstream of the protrusion in the flow direction and between the downstream-side stack and the bottom wall, and
the downstream-side thermally conductive portion is smaller in thickness than the upstream-side thermally conductive portion.

2. The power storage device according to claim 1, wherein the downstream-side thermally conductive portion is gradually reduced in thickness toward a downstream side in the flow direction.

3. The power storage device according to claim 1, further comprising a pressing member that presses the power storage module against the bottom wall, wherein
the pressing member includes
an upstream-side pressing portion that presses an upstream-side end portion of the upstream-side stack in the flow direction against the bottom wall, and
a downstream-side pressing portion that presses a downstream-side end portion of the downstream-side stack in the flow direction against the bottom wall, and
the downstream-side pressing portion presses the downstream-side end portion of the downstream-side stack against the bottom wall such that the downstream-side thermally conductive portion becomes smaller in thickness than the upstream-side thermally conductive portion.

4. The power storage device according to claim 3, wherein
the upstream-side pressing portion includes
an upstream-side bracket that serves to attach the upstream-side stack to the case,
a first upstream-side fastening member that fastens the upstream-side bracket to the upstream-side stack, and
a second upstream-side fastening member that fastens the upstream-side bracket to the case,
the downstream-side pressing portion includes
a downstream-side bracket that serves to attach the downstream-side stack to the case,
a first downstream-side fastening member that fastens the downstream-side bracket to the downstream-side stack, and
a second downstream-side fastening member that fastens the downstream-side bracket to the case,
a dimension between the downstream-side bracket and the case is larger than a dimension between the upstream-side bracket and the case,
the dimension between the downstream-side bracket and the case is a dimension in a state before the intermediate plate is placed on the protrusion, the downstream-side bracket is fixed to the downstream-side stack by the first downstream-side fastening member, and the downstream-side bracket is fixed to the case by the second downstream-side fastening member, and
the dimension between the upstream-side bracket and the case is a dimension in a state before the intermediate plate is placed on the protrusion, the upstream-side bracket is fixed to the upstream-side stack by the first upstream-side fastening member, and the upstream-side bracket is fixed to the case by the second upstream-side fastening member.
